(19) United States
(12) Patent Application Publication
(10) Pub. No.: US 2026/0133807 A1
(43) Pub. Date: May 14, 2026

(54) CONFIGURATION ANALYSIS BY POLICY ADHERENCE

(71) Applicant: International Business Machines Corporation, Armonk, NY (US)

(72) Inventors: Tim Uwe Scheideler, Schoenenberg (CH); Matthias Seul, Folsom, CA (US); Andrea Giovannini, Zurich (CH); Srinivas Babu Tummalapenta, Broomfield, CO (US)

(21) Appl. No.: 18/942,040

(22) Filed: Nov. 8, 2024

(51) Int. Cl. G06F 9/445

(52) U.S. Cl. CPC G06F 9/44505

(57) ABSTRACT

A method, according to one approach, is for identifying relevant policies applicable to a configuration of a computing environment. The method includes preprocessing the configuration of the computing environment and policies. The preprocessing includes splitting the configuration into entities and respective metadata. Moreover, summaries of the entities and the respective metadata are created using a trained machine learning model. The method further includes computing relevance and adherence of the entities with the policies by processing at least one of the summaries. The entities are grouped into configuration blocks based at least in part on embedded vectors in the entities. Relevance and adherence of the configuration blocks are further computed with the policies. Furthermore, a final report is prepared by selecting those configuration blocks with a highest relative relevance and lowest relative adherence.

### BACKGROUND

The present invention relates to compute systems, and more specifically, this invention relates to compute system policies.

Data production has continued to increase, particularly as computing power advances rapidly over time. While cloud computing has been implemented in conventional systems in an effort to improve the ability to process this increasing amount of data, moving sensitive workloads to the cloud requires a secure cloud infrastructure. For example, the process of moving certain workloads to cloud for computation efficiency assumes the cloud to be secure.

Keeping systems healthy from a security perspective means establishing a baseline of settings (e.g., configuration hardening or patch level), comparing the current baseline with the recommended status, and finally remediating any identified issues. This approach is common in conventional products, some of which will manage “system health”, based on industry standard benchmarks. However, establishing a baseline involves a set of individuals with applicable experience and skill to determine specific things to check and monitor, as well as the specific values that are desired with respect to security outcome and hardening.

### SUMMARY

A method, according to one approach, is for identifying relevant policies applicable to a configuration of a computing environment. The method includes preprocessing the configuration of the computing environment and policies. The preprocessing includes splitting the configuration into entities and respective metadata. Moreover, summaries of the entities and the respective metadata are created using a trained machine learning model. The method further includes computing relevance and adherence of the entities with the policies by processing at least one of the summaries. The entities are grouped into configuration blocks based at least in part on embedded vectors in the entities. Relevance and adherence of the configuration blocks are further computed with the policies. Furthermore, a final report is prepared by selecting those configuration blocks with a highest relative relevance and lowest relative adherence.

A computer program product, according to another approach, is for identifying relevant policies applicable to a configuration of a computing environment. The computer program product includes one or more computer-readable storage media. The computer program product further includes program instructions that are stored on the one or more storage media to perform the foregoing method.

A computer system, according to yet another approach, is for identifying relevant policies applicable to a configuration of a computing environment. The computer system includes a processor set, and one or more computer-readable storage media. The computer system further includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one

approach.

FIG. 2 is a representational view of a distributed system, in accordance with one approach.

FIG. 3A is a flowchart of a method, in accordance with one approach.

FIG. 3B is a flowchart of steps for the operations in the method of FIG. 3A, in accordance with one approach.

FIG. 4A is a partial representational view of a logical system, in accordance with an in-use example.

FIG. 4B is a partial representational view of the relationship between configuration entities and policies, in accordance with an in-use example.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods, and computer program products for identifying relevant policies applicable to a configuration of a computing environment. This is achieved at least in part by evaluating system configuration information with models that are trained to break down a complete scan of a computer system into meaningful parts, and further identify meaningful subsets of configuration entities that do or do not comply with a variety of policies. Approaches herein may thereby report an adherence of the configuration to the relevant policies, e.g., as will be described in further detail below.

In one general approach, a method is for identifying relevant policies applicable to a configuration of a computing environment. The method includes preprocessing the configuration of the computing environment and policies. The preprocessing includes splitting the configuration into entities and respective metadata. Moreover, summaries of the entities and the respective metadata are created using a trained machine learning model. The method further includes computing relevance and adherence of the entities with the policies by processing at least one of the summaries. The entities are grouped into configuration blocks based at least in part on embedded vectors in the entities. Relevance and adherence of the configuration blocks are further computed with the policies. Furthermore, a final report is prepared by selecting those configuration blocks with a highest relative relevance and lowest relative adherence.

In another general approach, a computer program product is for identifying relevant policies applicable to a configuration of a computing environment. The computer program product includes one or more computer-readable storage media. The computer program product further includes program instructions that are stored on the one or more storage media to perform the foregoing method.

In yet another general approach, a computer system is for identifying relevant policies applicable to a configuration of a computing environment. The computer system includes a processor set, and one or more computer-readable storage media. The computer system further includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved policy application code at block 150 for identifying relevant policies applicable to a configuration of a computing environment. This is achieved at least in part by evaluating system configuration information with models that are trained to break down a complete scan of a computer system into meaningful parts, and further identify meaningful subsets of configuration entities that do or do not comply with a variety of policies. Approaches herein may thereby report an adherence of the configuration to the relevant policies, e.g., as will be described in further detail below.

In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

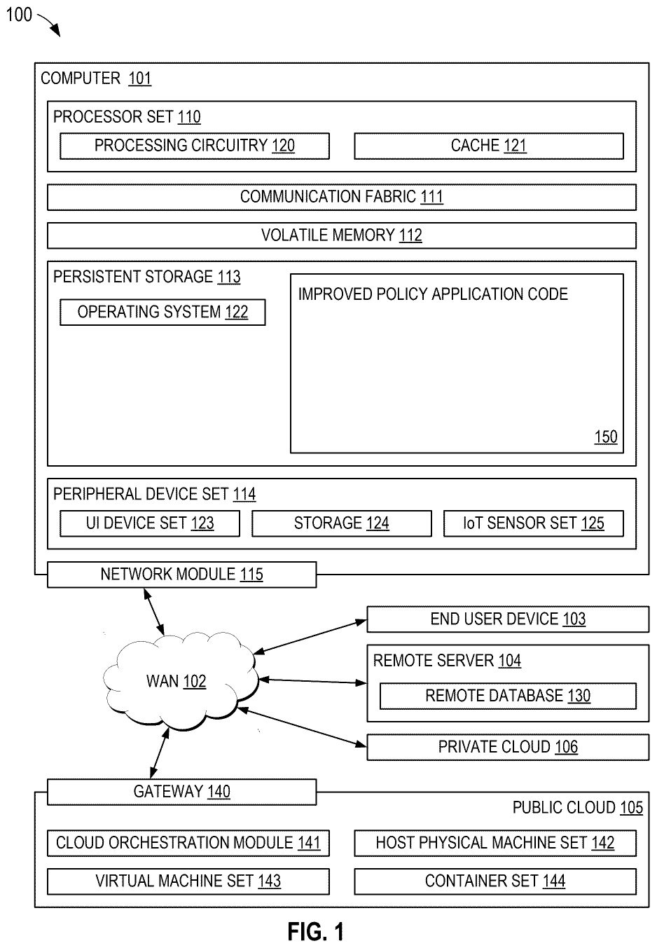

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (Eud) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, data production has continued to increase, particularly as computing power and the use of IoT devices continue to advance. For instance, the rise of smart enterprise endpoints has led to large amounts of data being generated at remote locations. Data production will only further increase with the growth of 5G networks and an increased number of connected mobile devices. This issue has also become more prevalent as the complexity of machine learning models increases. Increasingly complex machine learning models translate to more intense workloads and increased strain associated with applying the models to received data. The operation of conventional implementations has thereby been negatively impacted.

While cloud computing has been implemented in conventional systems in an effort to improve the ability to process this increasing amount of data, moving sensitive workloads to the cloud requires a secure cloud infrastructure. For example, the process of moving certain workloads to cloud for computation efficiency assumes (e.g., requires) the cloud to be secure. While conventional container orchestration platforms have provided some security measures for cloud workloads, they are fragmented and inefficient at protecting against advanced threats, e.g., such as Layer-7 threats. These conventional platforms are also unable to scale properly, thereby limiting application of a platform to a select set of circumstances.

Keeping systems “healthy” from a security perspective means establishing a baseline of settings (e.g., configuration hardening or patch level), comparing the current baseline with the recommended status, and finally remediating any identified issues. This approach is common in conventional products, some of which will manage “system health”, based on industry standard benchmarks. However, a key challenge is the establishment of a baseline defined by the tool vendor. This involves a set of individuals with applicable experience and skill to determine specific things to check and monitor, as well as the specific values that are desired with respect to security outcome and hardening. This is a significantly time-consuming and laborious process which is reflected in the license cost of these conventional products.

Moreover, the baseline is made without taking any of the policies defined by the organization (e.g., using a vulnerability management tool) into account. Conventional products are thereby limited to only validating predefined settings against common baseline, and not against any more specific policies, e.g., such as organizational policies. These conventional products are also notably limited to offering vulnerability detection in some areas (e.g., like firewall rules) if it is done completely manually in an annual review.

In sharp contrast to these conventional shortcomings, approaches herein are desirably able to find an anomalous system among a large set of healthy systems in an automated manner by comparing system configurations against the organization specifications (e.g., policies). Deviations may further be presented to a system administrator to take remediation actions. Approaches herein are thereby applicable to new and existing products by providing system security scans on system component (e.g., in large cloud based infrastructures) with applicability across industries. Approaches herein are further able to provide vulnerability scanning across large, inhomogeneous environments in alignment with hybrid cloud strategy with a proliferation of machine learning methods.

For instance, approaches herein identify parts of a system configuration which are not aligned with a set of policies (e.g., defined by an organization) and therefore pose a potential security threat. These approaches utilize AI based models (e.g., such as large language models) to convert non-standardized inputs into a standardized output. In some implementations, the inputs include scanned system configurations that may be provided by a system scanner. In some approaches, the system scanner is a physical device that is positioned near, attached to, included in, etc., a compute system configuration. In other approaches, the system scanner is a logical device (e.g., component) that is stored in memory, run by one or more processors, etc., ultimately causing various details of a compute system to be scanned. The system scanner may produce the configuration scan result in a structed text format, e.g., such as HTML, XML, etc. The scanned inputs may include metadata (e.g., OSQUERY) which is used to group the inputs by the source and purpose of the configuration. The scanned inputs may also include raw input without metadata in some situations. Here, the grouping may be performed by text parsing based on rule(s) and/or machine learning, e.g., as would be appreciated by one skilled in the art after reading the present description.

The system configuration is further broken down into elementary configuration entities (also referred to herein as “entities” or “configuration snippets”). For instance, the elementary configuration entities may include the patch level, directories excluded from antivirus, a firewall rule, etc. Each configuration snippet is further summarized by a LLM into syntactic language. The organization policies may further be defined in (e.g., converted into) syntactic language. The policies can thereby be broken down into individual statements that may be summarized by one or more AI based models (e.g., a LLM) to align the wording.

The configuration snippets are compared against (e.g., matched to) the policy statements in an effort to identify the closest matches. Specifically, the closest matching configuration snippet in terms of relevance to the policy is analyzed for compliance or non-compliance with the policy. A report which highlights configuration entities that are identified as adhering to a specific policy (in other words, a relevant policy statement exists) but are not aligned with the policy. System configurations that correspond to these entities that are not aligned with one or more policies may thereby be removed, edited, replaced, etc. in an effort to conform the system configuration with the relevant policies. Moreover, the policies may include security policies, data policies, communication policies, etc. and/or combinations thereof.

Approaches herein are thereby able to automatically process system configuration scans and match sections of the configuration scans to the corresponding policies (e.g., of a given organization). Configurations that violate one or more of these policies may thereby be brought to the attention of an administrator for adjustment and/or replacement. Additionally, policies that are not applicable to a given system configuration and poorly formulated policies may be identified and brought to the attention of the source (e.g., an organization) for updating, e.g., as will be described in further detail below.

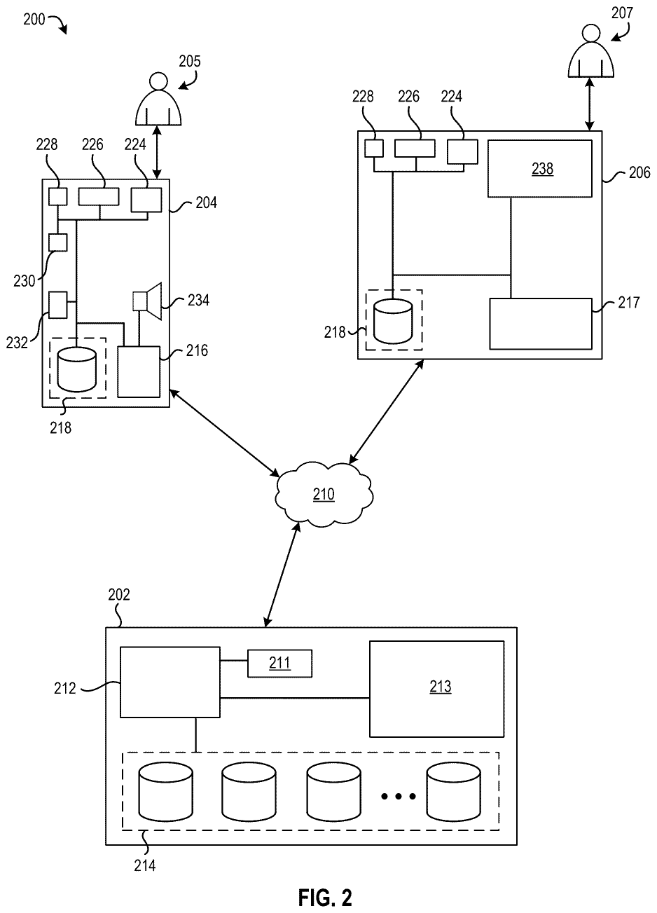

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to a user device 204, and edge node 206 accessible to the user 205 and administrator 207, respectively. The user device 204 and edge node 206 may thereby be considered “endpoint devices,” each of which are connected to the central server 202. The central server 202, user device 204, and edge node 206 are each connected to a network 210, and may thereby be positioned in different geographical locations. The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between user device 204, edge node 206, and/or central server 202, regardless of the amount of separation which exists therebetween, e.g., despite being positioned at different geographical locations. According to some approaches, the central server 202 is a remote cloud server that is connected to (e.g., may be accessed by) user device 204 and/or edge node 206.

However, it should be noted that two or more of the user device 204, edge node 206, and central server 202 may be connected differently depending on the approach. According to an example, which is in no way intended to limit the invention, two servers (e.g., nodes) may be located relatively close to each other and connected by a wired connection, e.g., a cable, a fiber-optic link, a wire, etc. ; etc., or any other type of connection which would be apparent to one skilled in the art after reading the present description.

The terms “user” and “administrator” are in no way intended to be limiting either. For instance, while users and administrators may be described as being individuals in various implementations herein, a user and/or an administrator may be an application, an organization, a preset process, etc. The use of “data,” “datasets,” “metadata,” and “information” herein are in no way intended to be limiting either, and may include any desired type of details, e.g., depending on the type of operating system implemented on the user device 204, edge node 206, and/or central server 202. In some approaches, datasets of textual entries (e.g., strings of alphanumeric characters) may be generated and used at the edge node 206 to form policies which outline how different aspects of the system configuration implemented at the edge node 206 are desired to operate. For example, an organization may create security policies that outline how various aspects of a given computing environment should be configured and/or operate. These security policies may thereby be implemented (e.g., enforced) at an intended edge server and/or a central server.

With continued reference to FIG. 2, the central server 202 includes a large (e.g., robust) processor 212 coupled to a cache 211, an AI module 213, and a data storage array 214 having a relatively high storage capacity. The AI module 213 may include any desired number and/or type of AI-based models, e.g., such as machine learning models, deep learning models, neural networks, etc. In preferred approaches, the AI module 213 includes models that have been trained to automatically process (e.g., inspect and evaluate) system configurations and make comparisons with corresponding policies. In some approaches, the models are trained to evaluate scans of system configurations and make comparisons with one or more policies. In other approaches, the models are trained to convert machine code, pseudo code, plain text, etc. into elements and metadata that represent respective details of a system configuration. The models may further be trained to identify elements of configurations that violate one or more of these policies and cause adjustments to be made to the configurations and/or policies, e.g., as will be described in further detail below.

With continued reference to FIG. 2, user device 204 includes a processor 216 which is coupled to memory 218. The processor 216 receives inputs from and interfaces with user 205. For instance, the user 205 may input information using one or more of: a display screen 224, keys of a computer keyboard 226, a computer mouse 228, a microphone 230, and a camera 232. The processor 216 may thereby be configured to receive inputs (e.g., text, sounds, images, motion data, etc.) from any of these components as entered by the user 205. These inputs typically correspond to information presented on the display screen 224 while the entries were received. Moreover, the inputs received from the keyboard 226 and computer mouse 228 may impact the information shown on display screen 224, data stored in memory 218, information collected from the microphone 230 and/or camera 232, status of an operating system being implemented by processor 216, etc. The electronic device 204 also includes a speaker 234 which may be used to play (e.g., project) audio signals for the user 205 to hear.

Looking now to the edge node 206, some of the components included therein may be the same or similar to those included in user device 204, some of which have been given corresponding numbering. For instance, controller 217 is coupled to memory 218, a display screen 224, keys of a computer keyboard 226, and a computer mouse 228. Additionally, the controller 217 is coupled to an AI module 238.

As described above with respect to AI module 213, the AI module 238 may include any desired number and/or type of AI-based models, e.g., such as machine learning models, deep learning models, neural networks, etc. However, in preferred approaches the AI module 238 includes models that have been trained to automatically process (e.g., inspect and evaluate) system configurations and make comparisons with corresponding policies. In some approaches, the models are trained to evaluate scans of system configurations and make comparisons with one or more policies. In other approaches, the models are trained to convert machine code, pseudo code, plain text, etc. into elements and metadata that represent respective details of a system configuration. The models may further be trained to identify elements of configurations that violate one or more of these policies and cause adjustments to be made to the configurations and/or policies, e.g., as will be described in further detail below.

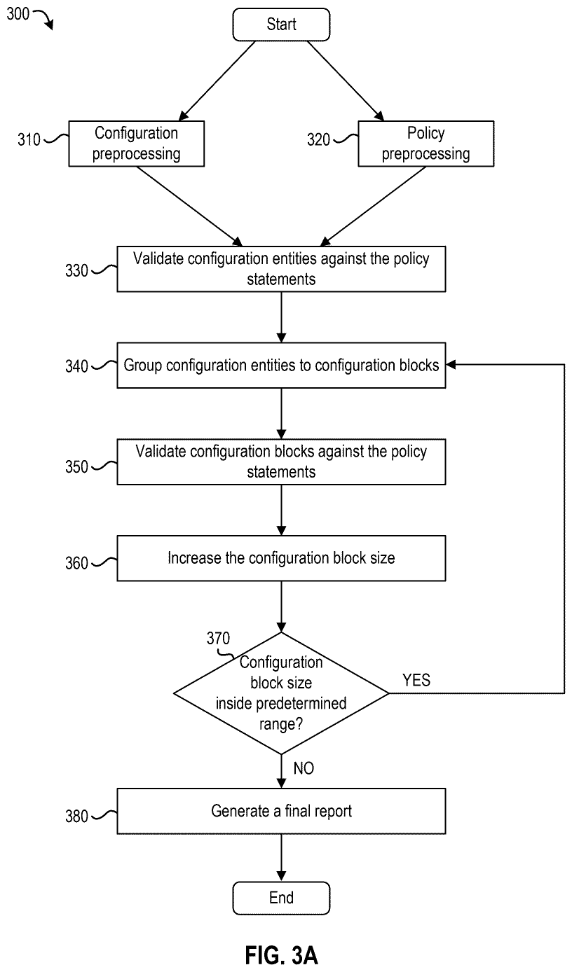

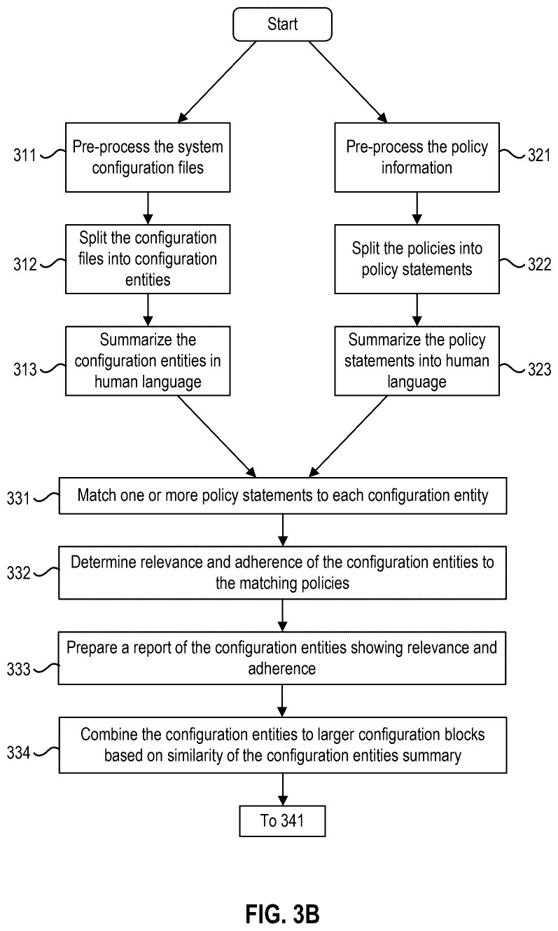

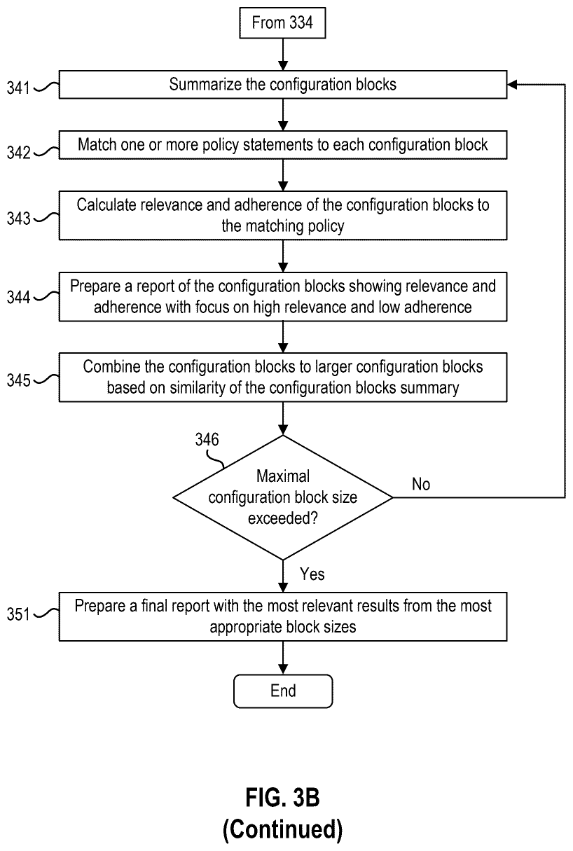

Looking now to FIG. 3A, a flowchart of a computer-implemented method 300 for identifying relevant policies applicable to a configuration of a computing environment, is illustrated in accordance with one approach. As noted above, this is achieved at least in part by evaluating system configuration information with models that are trained to break down a complete scan of a computer system into meaningful parts, and further identify meaningful subsets of configuration entities that do or do not comply with a variety of policies. Method 300 may thereby report an adherence of the configuration to the relevant policies, e.g., as will be described in further detail below.

The method 300 may be performed in accordance with the present invention in any of the environments depicted in FIGS. 1-2, among others, in various approaches. Moreover, more or less operations than those specifically described in FIG. 3A may be included in method 300, as would be understood by one of skill in the art upon reading the present descriptions.

Each of the steps of the method 300 may be performed by any suitable component of the operating environment using known techniques and/or techniques that would become readily apparent to one skilled in the art upon reading the present disclosure. For instance, one or more operations in method 300 may be performed by components in the processor system of FIG. 2. According to one approach, a processor at a central server (e.g., see processor 212) may receive the configuration of a remote computing environment (e.g., see edge node 206) and perform one or more of the operations in method 300. The processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

As shown, operations 310 and 320 include performing preprocessing. Operation 310 includes preprocessing information that is associated with the configuration of a computing environment. In other words, operation 310 includes preprocessing details that pertain to the specific configuration that a given computing environment implements. This may include physical components, logical components (e.g., files), running applications, data stored in transitory memory, etc. In some approaches, the details outlining the configuration may be split into elementary configuration entities (also referred to herein as “configuration snippets”) and respective metadata. These elementary configuration entities or “entities” thereby represent certain characteristics of the corresponding configuration. In some approaches, operation 310 includes splitting the configuration information into configuration snippets and respective metadata.

Looking now to operation 320, there one or more policies are preprocessed. As noted above, any desired number of policies may be created and used to influence or control different aspects of a compute environment. Preprocessing the policies and corresponding information (e.g., metadata) allows for details to be extracted and more easily compared to aspects of a configuration being evaluated. In some approaches, operation 320 includes using a trained machine learning model, e.g., such as an LLM, to evaluate one or more policies generated by an organization.

From operation 320, method 300 advances to operation 330. There, operation 330 includes comparing the configuration of the compute environment with the policies. Entities that have been extracted from the configuration information are compared with the policies. Again, by preprocessing the configuration information and policies, this comparison is performed efficiently and provides valuable insight. In some approaches, the configuration information and policies are compared by computing relevance and adherence of at least one of the entities with the respective policies.

From operation 330, method 300 advances to operation 340. There, operation 340 includes grouping the configuration entities into configuration blocks. In other words, operation 340 includes creating a grouping of configuration entities and using the grouping to form a configuration block. In some approaches, the configuration entities are grouped into the different configuration blocks based at least in part on embedded vectors in the entities. Moreover, by adjusting the size of the configuration blocks (e.g., the number of configuration entities therein), method 300 is able to break down a complete scan of a computer system into meaningful parts, and further identify meaningful subsets of configuration entities that do or do not comply with a variety of policies. This is in sharp contrast to simply comparing individual, elementary configuration entities to a policy which does not provide detailed insight. Rather, creating meaningful groups of elementary configuration entities that are then compared to policies allow for improved adherence. For instance, operations in method 300 allow for comparison between individual settings to identify inconsistencies and/or contradictions therebetween, e.g., as will be described in further detail below.

From operation 340, method 300 advances to operation 350. There, operation 350 includes validating the configuration blocks against the policy statements. In other words, operation 350 includes computing the relevance and adherence of the entity groupings in the configuration blocks formed in operation 340, with a desired number of policies.

From operation 350, method 300 advances to operation 360 where the size of the configuration blocks is increased. As noted above, by varying (e.g., incrementing) the size of the configuration blocks, approaches herein are desirably able to develop a detailed evaluation (e.g., comparison) of a compute system configuration to a set of policies. For instance, grouping the entities into the configuration blocks may include varying a size of the configuration blocks, computing the uncertainty (i.e., the variance between multiple adherence predictions), and successively selecting combinations of configuration blocks and policies with a lowest variance.

Proceeding to operation 370, there a determination is made as to whether the configuration block size is still inside a predetermined range. In response to determining the configuration block side is still in the predetermined range, method 300 returns to operation 340 such that subsequent groupings of configuration entities may be made to form new configuration blocks. These new configuration blocks may thereby be compared to the policies in operation 350. Again, operations 340, 350, 360, 370 may be repeated any desired number of times. However, in response to determining that the configuration block side is not in the predetermined range at operation 370, method 300 advances to operation 380. There, operation 380 includes generate and output a final report that identifies the configuration blocks that are of interest. For example, the final report may select those configuration blocks with a highest relative relevance and clear policy violations manifested through lowest relative adherence. In other approaches, the report may identify configuration blocks with a lowest relative relevance and no policy violations manifested through high relative adherence.

It follows that the operations of method 3A are able to evaluate system configuration information with models that are trained to break down a complete scan of a computer system into meaningful parts, and further identify meaningful subsets of configuration entities that do or do not comply with a variety of policies. This is in sharp contrast to simply comparing individual, elementary configuration entities to a policy which does not provide the full picture. Rather, creating meaningful groups of elementary configuration entities that are then compared to policies allow for improved adherence. For instance, operations in method 300 allow for comparison between individual settings to identify inconsistencies and/or contradictions therebetween. The challenge is that configuration entities which belong to the same meaningful group are not necessarily adjacent each other. However, by performing an initial matching of configuration entities with policy statements, as well as matching of configuration blocks, along with iteratively increasing the block size until a predefined threshold is exceeded, approaches herein are able to overcome any conventional setbacks.

Looking now to FIG. 3B, a detailed view of exemplary steps (e.g., sub-operations) that may be performed for operations of method 300 are illustrated in accordance with one approach. It follows that one or more of these steps may be used to perform the respective operations of FIG. 3A. However, it should be noted that the steps of FIG. 3B are illustrated in accordance with one approach which is in no way intended to be limiting.

FIG. 3B thereby illustrates steps that are able to achieve compute system configuration preprocessing and policy preprocessing, processing of configuration entities, as well as the identification of applicable policies. Moreover, by grouping of configuration entities and measuring the adherence of the configuration blocks to the policies, the steps are able to ultimately produce a final report that summarizes the gained understanding, e.g., as will be described in further detail below.

As shown, step 311 includes pre-process the system configuration files. It follows that step 311 corresponds to operation 310 of FIG. 3A. In some approaches, the systems configuration files (e.g., information) are scans that are provided by a physical and/or logical system scanner. The system configuration files may thereby have metadata attached thereto, which may indicate the type of configuration (e.g., OS configuration), antivirus settings, network settings, security system settings, application settings, web proxy configurations, firewall rules, etc. In situations where the input contains metadata (e.g., OSQUERY), the metadata is used to group the input by the source and purpose of the configuration. In case the scanner provides raw input without metadata, a grouping may be performed by text parsing based on rule(s) and/or machine learning.

The result (e.g., output) produced by performing step 311 preferably includes a set of system configuration files Each file may cover a specific topic and may include an arbitrary number of entries (e.g., sections marked by delimiters, single lines, etc.). The entries can also be of an arbitrary order, e.g., related entries can be distributed across the file.

Proceeding to step 312, there method 300 includes splitting the configuration files into configuration entities. Each configuration file is preferably broken down into configuration entities. A configuration entity may include a single line or a single section (e.g., marked by hypertext delimiters) in one of the configuration files. Thus, as part of the metadata, some configuration entities may include additional information, e.g., comments next to a firewall about the purpose of the rule. However, other configuration entities may not contain additional information.

In one implementation, supervised machine learning is used to improve the interpretation of uncommented configuration entities. For example, part of the system configuration for which a purpose is known (e.g., a comment on the purpose exists) may be used. This, a particular group which contains a sufficient large number of configuration samples, e.g. firewall rules, may be selected. Moreover, the machine learning model may be trained by using the configuration entity as a sample and the comment as label. In the inference phase, the machine learning model may also be used to assign additional information to the unlabeled configuration entities. As a result, a table with metadata (e.g., index number, topic, comment, generated values, etc.) is created for each configuration entity.

The topic relates to scope and/or context of the configuration entity may apply to the respective, e.g., network (host, IP, port, segment, etc.), file system (path, file, permissions, etc.), users (authorization, permissions, etc.), application specific settings, etc.

Step 313 further includes summarize the configuration entities. Each configuration entity including its metadata (topic, comment, etc.) may be summarized into a desired format, style, location, etc. For example, the configuration entities may be converted into syntactic language using one or more LLMs. The summaries (e.g., results) may further be stored in a table. For example, a table with the index number, and syntactic language summary may be used to store the summaries.

Looking now to step 321, pre-processing policy information corresponds to operation 320 of FIG. 3A. As noted above, the policy information may include inspecting and evaluating any IT policies, security policies, data privacy policies, etc., which may be at least summarized in one or more documents. These documents are fed into the systems and metadata (e.g., document name, size, source language, headings, etc.) is created.

Step 322 further includes splitting the policies into policy statements. The policies are preferably split into individual policies statements and metadata assigned to the policy statements, e.g., user policy, nr. 12, The minimal password length must be at least 8 characters, network policy, nr. 3, Internet facing web servers must not use the HTTP protocol. Moreover, a table incorporating metadata (e.g., index number, topic, comment(s), etc.) is created for each policy statement created in step 322.

Step 323 further includes summarizing the policy statements into a desired format. In some approaches, while a policy statement may already be expressed in syntactic form, using one or more trained models (e.g., LLMs) to evaluate and/or modify the policy statements may help express them in a “standardized” language. For instance, the wording that is generated by a LLM may be most accurately interpreted by the LLM in subsequent steps.

Looking now to step 331, one or more policy of the statements are matched to each configuration entity. Step 331 may thereby include processing of configuration entities and identifying policies that correspond thereto, e.g., see operation 330 of FIG. 3A. As noted above, operation 330 includes determining the correct level of granularity for a meaningful validation of the configuration against the applicable policy. In some approaches operation 330 may operate “fine grain to coarse grain”, starting with individual configuration entities and grouping them into meaningful blocks.

In one implementation, step 331 includes applying all policy statements against each configuration entity. However, this “brute force” approach consumes a substantial amount of computing resources. In another implementation, the metadata (providing information about the context and the purpose) is used to preselect potentially applicable policies for each configuration entity. One or more metadata similarity matching processes can further be applied, e.g., such as analytical methods like cosine similarity, LEVENSHTEIN distance, transformer models, etc. The broadness of the similarity may be adjusted by the results of the subsequent step, if too few or too many policies regarded as relevant, as will soon become apparent.

Looking now to step 332, the relevance and adherence of the configuration entities to the matching policies is determined. According to an example, for each pair of [text summary of the configuration entity, policy statement], two parameters may be calculated. These include the relevance “R”, which may range from 0 (irrelevant) to 1 (highly relevant), and the adherence “A”, which may range from 0 (configuration entity violates explicit the policy statement) to 1 (the policy statement explicitly requests the configuration entities as it is). Thus, relevance R=0 automatically translates to an adherence of A=0.5, as the policy is not applicable, causing the configuration item to neither violates the policy, nor conform to the policy.

Moreover, relevance may be computed using an ensemble approach based at least in part on using a same LLM as implemented in operation 320 of FIG. 3A. For instance, the LLM may be used to evaluate the text summary of the configuration entity, where policy statements are passed to the LLM without the final few (e.g., 2, 3, 4, etc.) layers, along with 2 vectors. One of the vectors corresponds to a text summary of the configuration entity, while another of the vectors corresponds to the policy statement(s), and may be extracted from the relevant information. The vectors may further be compared using similarity determinations (e.g., cosine), which may further be normalized between 0 and 1. It follows that in some approaches, the embedded vectors of the configuration entities (and similarly embedding vectors for the configuration blocks and/or policies) are extracted from one of the last final layers of a large language model trained by reconstructing tokens from a dataset specific for policies and configurations, e.g., as would be appreciated by one skilled in the art after reading the present description.

In another implementation, a matching algorithm for specific keywords and their surroundings may be implemented in order to determine relevance and/or adherence in step 332. For example, given a predefined dictionary of relevance words (e.g., such as network, host, port, protocol, operating system, permissions, authentication, authorization, etc.), the algorithm may be configured to identify these words in both the text summary of the configuration entity and in the policy statements. The algorithm may further store the matches together with the surrounding content (e.g., syntactic words with prepositions intentionally excluded therefrom). The matches between the configuration entities and the policy information are thereby assembled together in tuples, exploring all combinations of the matching lists. In preferred approaches, each combination a respective LEVENSHTEIN score is computed. The final score from this matching algorithm may be the number of tuples with a LEVENSHTEIN score that is larger than 0.9 divided by all the matches found in the text summary of the configuration entity.

In other approaches, adherence may be determined (e.g., computed) using one or more AI based trained models (e.g., LLMs) to extract salient configuration information from the configuration entities. These models may also be configured to determine the salient configuration entities associated with adhering to the respective policies. The results may further be combined and used to compute a similarity between the results, and this similarity may be normalized between 0 and 1.

In still other approaches, a matching algorithm may be used at least in part to perform the relevance computation. For instance, the matching algorithm may apply a different adherence specific dictionary, e.g., which includes terms such as must, must not, should, should not, allowed, forbidden, permitted, prohibited, etc.

With continued reference to FIG. 3B, step 333 includes preparing a report which includes the relevance and adherence of certain configuration entities. In some approaches, the report may be generated with focus on configuration entities that had high relevance and low adherence. In some approaches, the report generated in step 333 includes multiple sections. For instance, the report may include a section that includes configuration entities which violate one or more policies. In other words, the report may identify matches with large R and small A values. For example, predetermined thresholds may be set for R and/or A. For each non-conform configuration entity the report may identify the actual configuration (e.g., single line or block between hypertext delimiters), the most relevant policy statements with the relevance score “R” and adherence level “A”. In situations where more than one policy is applicable and not adhered to, these policy statements are also preferably shown.

In some approaches, the report identifies configuration entities which are conform with the applicable policies, i.e., matches with large R and large A, based on predefined minimal values. In other approaches, the report identifies configuration entities which are not covered by a policy (or for which a policy with minimal R could not be identified). In still other approaches, the report identifies policies statements which did not apply to any (or a very few) configuration entities. These policy statements may simply be not applicable as they are non-technical (e.g., statements about expected user behavior) or they are poorly formulated. While certain reports may be configured to inform a user of the weakness and strength of the current overall system configuration, other reports may be generated in an effort to consider adding a new policy statement and/or improving the formulation of existing policy statements.

In some approaches, the relevance and adherence of the entities with the respective policies may be determined by computing a relative distance of the embedded vectors in the respective entities. Determining the relevance and adherence may further include determining a frequency of matches against a predefined relevance dictionary and/or a predefined adherence dictionary, e.g., as described herein.

Advancing to step 334, the configuration entities are combined into larger configuration blocks, e.g., based on similarity of the configuration entities summary. The configuration blocks may vary in size, e.g. as described above. For instance, in some approaches a configuration block may include five blocks for web server configuration, or many configuration entities, e.g., thousand firewall rules. To cover different configuration aspects (e.g., single value misconfigurations vs. inconsistent system setups) the steps herein preferably follow a fine grained analysis to coarse grained analysis. Again, this may be achieved at least in part by converting the configuration entities (including the corresponding metadata) into syntactic language (e.g., human language). Moreover, the embedding of the sentences describing each configuration entity may be calculated as a vector in a multidimensional space. At least one clustering algorithm (e.g., k-means, HDBSCAN, etc.) may further be applied to cluster the embeddings (e.g., based on proximity of the vectors), resulting in a set of clusters with similar sentences. In some approaches, the number of clusters “C” is determined by a clustering algorithm, while in other approaches the number of clusters “C” is derived from a number of configuration entities, e.g., number of clusters=SQRT(number of configuration entities). Moreover, create C configuration blocks “B” containing multiple configuration entities, e.g., one entity per embedding in the cluster.

Looking now to step 341, the groupings of configuration entities are compared to the policies to determine adherence and/or relevance thereof. Step 341 may thereby be associated with operation 340 of FIG. 3A. As shown, step 341 includes summarize each configuration block into a desired format. In one implementation only the configuration block is taken as input for the summary, in another implementation the human language summary of the configuration entities belonging to the block are taken as additional input, in another implementation the human language summary and metadata of the configuration entities (e.g., see step 312) belonging to the block are taken as additional input.

Metadata for each configuration block may be derived from the metadata of the configuration entities belonging to the block. In one implementation the most prevalent metadata is selected (e.g., most common topics among the configuration entities), in another implementation the metadata is summarized by an LLM (e.g., a summary of all the comments of the configuration entities belonging to the block). The results may further be stored in a table with the columns that include index number, metadata, configuration block, summary, etc.

Proceeding to step 342, one or more policy statements are matched to each configuration block. In other words, step 342 includes selecting the most appropriate policies for the configuration block. It follows that step 342 may implement any approaches described above, e.g., for each configuration entity. step 343 further includes calculating the relevance and adherence of the configuration blocks to the matching policies. In other words, step 343 includes determining (e.g., calculating) the relevance R and adherence A are for each configuration block.

Step 344 further includes preparing a report of the configuration blocks showing relevance and adherence. In some approaches, the report may be generated with a focus (e.g., emphasis or weight) on entities with high relevance and low adherence.

As noted above, the report may include any desired number of sections that present information as desired therein. For example, a report generated in step 344 may include configuration blocks violating one or more policies, configuration blocks which conform with the applicable policies, configuration blocks not covered by a policy, and policies statements which did not apply to any (or a very few) configuration blocks.

Proceeding to step 345, the configuration blocks are combined into larger configuration blocks based on similarity of the configuration blocks summary. In one implementation the clustering of the configuration entities is used, but the numbers of clusters reduced to create larger configuration blocks. In another implementation the embeddings of summaries of configuration blocks in human language are created and clustering is performed in the embedding vector space. In one implementation the same clustering algorithm is used for the configuration blocks as for the configuration entities. In another implementation a different clustering algorithm is used. For instance, grouping the entities into the configuration blocks may include varying a size of the configuration blocks, computing the uncertainty (i.e., the variance between multiple adherence predictions), and successively selecting combinations of configuration blocks and policies with a lowest variance.

Step 346 determines whether a size of the generated configuration block has exceeded a predetermined threshold. In one implementation the loop of creating increasingly larger clusters is stopped once the number of configuration entities in a configuration block exceeds a predefined number. In another implementation the block size is incrementally increased as the remaining configuration block is equivalent to the configuration file. The configuration block size is measured per configuration file. Thus, short configuration files (e.g., with 5 entries of web server configuration) are analyzed on configuration entity level and as a whole, while a firewall rule set with thousands of rules is analyzed in multiple iterations.

In response to determining the size of the configuration block(s) is greater than the threshold, the flowchart is shown as advancing to step 351. There, step 351 includes preparing a final report. In the present approach, the final report is identified as including the most relevant results from the most appropriate block sizes. However the final report may be generated to display any desired results generated by the one or more trained models herein.

Thus, for each configuration file (unless it is too short) there will be multiple iterations of checking conformity with different policies. For each level of detail, from single configuration entities to large groups of configuration entities, the policy relevance R and adherence A is calculated. In one implementation, for each configuration file the variance of adherence prediction for the level detail (block size) is calculated. This provides what parts of each block impact the level of adherence. This allows for approaches herein to pinpoint specific text parts causing policy violations.

In some approaches, the final report generated in step 351 focuses on the configuration blocks with the highest relevance (large R) and clear policy violations (small A). The report may be constructed using the best fitting configuration block size and the parts of the configuration block with most impact (e.g., changes of adherence) on the adherence prediction. Moreover, the report may include any desired number and/or arrangement of sections, e.g., as described above.

Again, approaches herein are desirably able to compare converted configurations with specific policies. Approaches herein can identify system configurations which are in violation of the policies, as well as identifying meaningful parts of the overall compute system configuration that may be validated against one or more of the policies. An entire system configuration cannot be compared against all policies, as the system would try to match too many items with each other that are simply not applicable. Moreover, considering only single configuration entities on their own cannot give a conclusive assessment of the configuration of a complex system.

Approaches herein are desirably able to match configuration information and policies using trained models, use free text (policies) as input instead of predefined analytic rules, define novel metrics to judge which policy statements are relevant and how well the configuration is aligned to the policies, etc. Approaches herein are even able to break down the configuration information into blocks of varying size to determine to best level of granularity while comparing against the policies. Thus, even attempts to generate service plans and provision instructions based on policies using rules, do not amount to identifying the best match between a specific set of existing policies and the computing environment. The adherence may also be evaluated in a similar manner, e.g., as described herein.

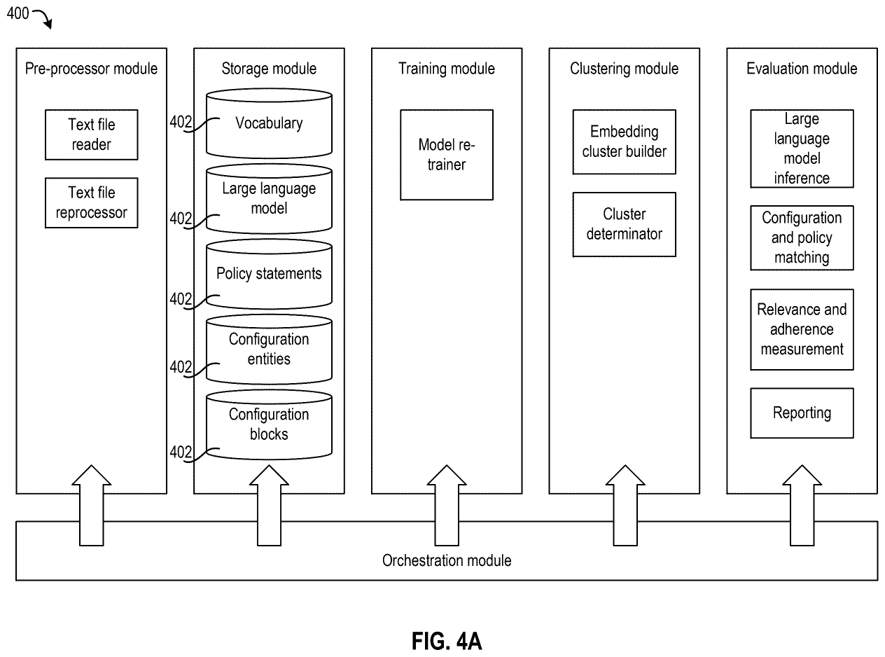

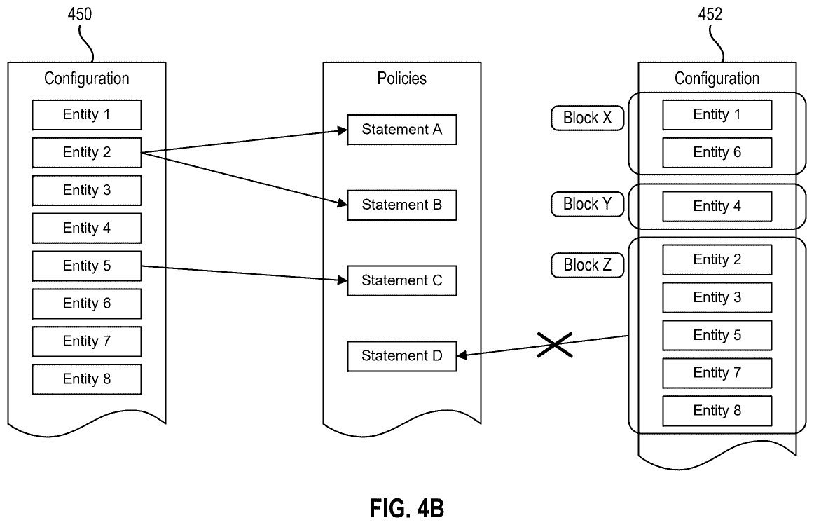

Looking now to FIG. 4A, a representational view of the logical components that may be used to perform one or more operations and/or steps in FIGS. 3A-3B are illustrated in accordance with an in-use example. Moreover, FIG. 4B depicts the relationship between configuration entities and policies in accordance with an in-use example.

Looking first to FIG. 4A, the logical system 400 includes an orchestration module that is connected to a number of other downstream modules. For instance, the orchestration module is connected to a pre-processor module, a storage module, a training module, a clustering module, and an evaluation module. Each of these modules may further be configured to perform one or more operations (and/or steps) in the approaches described herein. For instance, the pre-processor module includes a text file reader and a text file reprocessor. The pre-processor module may use this reader and/or reprocessor to interpret, process, and modify compute system configuration information (e.g., entities) and/or policy information.

The storage module further includes a number of data storage devices 402. While each data storage device 402 is illustrated as including a different type of data therein, it should be noted that the number and/or type of data storage devices that are used in the storage module varies depending on the desired approach. However, separating the vocabulary, from the LLMs, from the policy statements, from the configuration entities, from the configuration blocks ensures minimal data contamination.

The training model includes the model re-trainer which may be used to update one or more of the models (e.g., LLMs) implemented herein. The clustering module includes an embedding cluster builder and a cluster determinator, which may be used to generate and examine the different groupings of elements that are compared to the policies. Furthermore, the evaluation module includes LLM inference, Configuration and policy matching, relevance and adherence measurement, as well as reporting, e.g., as would be appreciated by one skilled in the art after reading the present description.

Looking now to FIG. 4B, a first compute system configuration 450 is divided into a plurality of entities Entity 1, Entity 2, Entity 3, etc. While each of these entities may be compared against the different relevant policy statements Statement A, Statement B, Statement C, Statement D, combinations (e.g., blocks) of configuration elements may be formed and compared against the policy statements. For example, the second compute system configuration 452 has formed blocks Block X, Block Y, Block Z of configuration entities, each of which may be compared against the different policy statements, e.g., to determine adherence and/or relevance thereof. For example, the configuration entities in Block Z are shown as being compared against, and violating, Statement D.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to learn how to automatically process (e.g., inspect and evaluate) system configurations and make comparisons with corresponding policies. In some approaches, the models are trained to evaluate scans of system configurations and make comparisons with one or more policies. In other approaches, the models are trained to convert machine code, pseudo code, plain text, etc. into elements and metadata that represent respective details of a system configuration. The models may further be trained to identify elements of configurations that violate one or more of these policies and cause adjustments to be made to the configurations and/or policies.

Initial training may include reward feedback that may, in some approaches, be implemented using a subject matter expert (SME) that generally understands the relationships between configurations and policies. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with a compute system configuration, because the neuromyotonic AI model may not need an SME and/or iteratively applied training with reward feedback in order to accurately perform operations described herein. Instead, the neuromyotonic AI model is configured to itself make determinations described in operations herein.

Weight values may, in some approaches, be used by the AI reasoning model to collect and analyze information and/or feedback potentially received in response to configuration elements being compared to policies. Such an AI model ensures that re-training occurs, during which the configuration elements are modified to become more compliant with the policies being applied by the AI model(s) is evaluated. In situations where adherence of the configuration elements declines, the data used to train the AI model(s) may be shifted (e.g., weighted) such that the AI model(s) produce more accurate assessments of a configuration, where the scale of such analysis and determinations would not otherwise be feasible for a human to perform. This is because humans are not able to efficiently perform complex re-training resulting from dynamic evaluation of compute system configurations to complex policies, and would otherwise incorporate processing delays and errors in the process of attempting to do so. Accordingly, management of operations described herein is not able to be achieved by human manual actions.

It will be clear that the various features of the foregoing systems and/or methodologies may be combined in any way, creating a plurality of combinations from the descriptions presented above.

It will be further appreciated that implementations of the present invention may be provided in the form of a service deployed on behalf of a customer to offer service on demand.

The descriptions of the various implementations of the present invention have been presented for purposes of illustration, but are not intended to be exhaustive or limited to the implementations disclosed. Many modifications and variations will be apparent to those of ordinary skill in the art without departing from the scope and spirit of the described implementations. The terminology used herein was chosen to best explain the principles of the implementations, the practical application or technical improvement over technologies found in the marketplace, or to enable others of ordinary skill in the art to understand the implementations disclosed herein.

What is claimed is:

1. A method for identifying relevant policies applicable to a configuration of a computing environment, comprising:
preprocessing the configuration of the computing environment and policies by:
splitting the configuration into entities and respective metadata, and
creating summaries of the entities and the respective metadata using a trained machine learning model;
computing relevance and adherence of the entities with the policies by processing at least one of the summaries;
grouping the entities into configuration blocks based at least in part on embedded vectors in the entities;
computing relevance and adherence of the configuration blocks with the policies; and
preparing a final report by selecting those configuration blocks with a highest relative relevance and lowest relative adherence.

2. The method of claim 1, wherein the computing the relevance and adherence of the entities with the policies by processing at least one of the summaries includes:
determining a relative distance of the embedded vectors in the respective entities, and
determining a frequency of matches against a predefined relevance dictionary and/or a predefined adherence dictionary.

3. The method of claim 2, wherein the predefined adherence dictionary contains terms selected from the group comprising: must, must not, should, should not, allowed, forbidden, permitted, and prohibited.

4. The method of claim 2, wherein the predefined relevance dictionary contains terms selected from the group comprising: network, host, port, protocol, operating system, permissions, authentication, and authorization.

5. The method of claim 1, wherein the configuration of the computing environment is defined by data selected from the group comprising: operating system settings, security system settings, network settings, firewall rules, and application settings.

6. The method of claim 1, wherein the grouping the entities into the configuration blocks includes:
varying a size of the configuration blocks;
computing variance between multiple adherence predictions; and
successively selecting combinations of configuration blocks and policies with a lowest variance.

7. The method of claim 6, wherein the entities are grouped into configuration blocks multiple different times, the multiple configuration blocks having varied sizes.

8. The method of claim 1, wherein the embedded vectors of the entities are extracted from final layers of a large language model trained by reconstructing tokens from a dataset specific for policies and configurations.

9. A computer program product for identifying relevant policies applicable to a configuration of a computing environment, the computer program product comprising:
one or more computer-readable storage media; and
program instructions stored on the one or more storage media to perform operations comprising:
preprocessing the configuration of the computing environment and policies by:
splitting the configuration into entities and respective metadata, and
creating summaries of the entities and the respective metadata using a trained machine learning model;
computing relevance and adherence of the entities with the policies by processing at least one of the summaries;
grouping the entities into configuration blocks based at least in part on embedded vectors in the entities;
computing relevance and adherence of the configuration blocks with the policies; and
preparing a final report by selecting those configuration blocks with a highest relative relevance and lowest relative adherence.

10. The computer program product of claim 9, wherein the computing the relevance and adherence of the entities with the policies by processing at least one of the summaries includes:
determining a relative distance of the embedded vectors in the respective entities, and
determining a frequency of matches against a predefined relevance dictionary and/or a predefined adherence dictionary.

11. The computer program product of claim 10, wherein the predefined adherence dictionary contains terms selected from the group comprising: must, must not, should, should not, allowed, forbidden, permitted, and prohibited.

12. The computer program product of claim 10, wherein the predefined relevance dictionary contains terms selected from the group comprising: network, host, port, protocol, operating system, permissions, authentication, and authorization.

13. The computer program product of claim 9, wherein the configuration of the computing environment is defined by data selected from the group comprising:
operating system settings, security system settings, network settings, firewall rules, and application settings.

14. The computer program product of claim 9, wherein the grouping the entities into the configuration blocks includes:
varying a size of the configuration blocks;
computing variance between multiple adherence predictions; and
successively selecting combinations of configuration blocks and policies with a lowest variance.

15. The computer program product of claim 14, wherein the entities are grouped into configuration blocks multiple different times, the multiple configuration blocks having varied sizes.

16. The computer program product of claim 9, wherein the embedded vectors of the entities are extracted from final layers of a large language model trained by reconstructing tokens from a dataset specific for policies and configurations.

17. A computer system for identifying relevant policies applicable to a configuration of a computing environment, the computer system comprising:
a processor set;
one or more computer-readable storage media; and
program instructions stored on the one or more storage media to cause the processor set to perform operations comprising:
preprocessing the configuration of the computing environment and policies by:
splitting the configuration into entities and respective metadata, and
creating summaries of the entities and the respective metadata using a trained machine learning model;
computing relevance and adherence of the entities with the policies by processing at least one of the summaries;
grouping the entities into configuration blocks based at least in part on embedded vectors in the entities;
computing relevance and adherence of the configuration blocks with the policies; and
preparing a final report by selecting those configuration blocks with a highest relative relevance and lowest relative adherence.

18. The computer system of claim 17, wherein the computing the relevance and adherence of the entities with the policies by processing at least one of the summaries includes:
determining a relative distance of the embedded vectors in the respective entities, and
determining a frequency of matches against a predefined relevance dictionary and/or a predefined adherence dictionary.

19. The computer system of claim 17, wherein the grouping the entities into the configuration blocks includes:
varying a size of the configuration blocks;
computing variance between multiple adherence predictions; and
successively selecting combinations of configuration blocks and policies with a lowest variance.

20. The computer system of claim 17, wherein the embedded vectors of the entities are extracted from final layers of a large language model trained by reconstructing tokens from a dataset specific for policies and configurations.
